(19) United States
(12) Patent Application Publication
(10) Pub. No.: US 2015/0336782 A1
(43) Pub. Date: Nov. 26, 2015

(54) CONTAINER OPENER

(71) Applicant: MARC BOYAJIAN, Tujunga, CA (US)

(72) Inventor: MARC BOYAJIAN, Tujunga, CA (US)

(21) Appl. No.: 14/284,204

(22) Filed: May 21, 2014

(51) Int. Cl. B67B 7/18; B67B 7/16; B67B 7/44; B67B 7/14

(52) U.S. Cl. CPC B67B 7/18; B67B 7/14; B67B 7/16; B67B 7/44

(57) ABSTRACT

A container opener is configured to remove a lid from a container. The container opener has a housing configured with a top slot and a front slot. An adjustable blade is inserted into the housing through the front slot and mechanically coupled to a movable jaw member. A slider and locking unit inserted into the top slot and attached to the adjustable blade such that movement of the slider within the top slot moves the adjustable blade in and out of the front slot. A stationary jaw member is attached to the housing. The movable jaw member is configured to be placed a distance from the stationary jaw member in order to hold the lid such that rotating the housing removes the lid from the container.

### BACKGROUND

The embodiments herein relate generally to tools which can be operated by human hands.

Prior to embodiments of the disclosed invention, human users had difficulty opening water bottles and containers by hand. The prior art includes: U.S. Patent Application publication 2013/0112064 filed by Ginter; U.S. Patent Application publication 2013/0081281 filed by Chu; and U.S. Pat. No. 6,142,769 issued to Walker.

Ginter does not teach an adjusting system where a first grip can move toward or away from a second grip. Chu teaches a blade attached to a casing and a second blade that can move in and out of the casing along a guiding shaft. A blade is different from a grip in that a blade is not configured to hold anything. Walker teaches a multi-tool with a retractable pen, while this moves in an out it is not configured to open containers.

### SUMMARY

A container opener is configured to remove a lid from a container. The container opener has a housing configured with a top slot and a front slot. An adjustable blade is inserted into the housing through the front slot and mechanically coupled to a movable jaw member. A slider and locking unit inserted into the top slot and attached to the adjustable blade such that movement of the slider within the top slot moves the adjustable blade in and out of the front slot. A stationary jaw member is attached to the housing. The movable jaw member is configured to be placed a distance from the stationary jaw member in order to hold the lid such that rotating the housing removes the lid from the container.

In some embodiments, the movable jaw member and the stationary jaw member can both be concave inward to better grip the container. The slider and locking unit can further comprise an arm mechanically coupled to a boss. The adjustable blade can be perforated at a connection point which can be configured to accommodate the boss. A rear surface on the housing can comprises a key ring which can further comprise a clasp.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of an embodiment of the invention in a retracted mode.

FIG. 2 is a perspective view of an embodiment of the invention in an extended mode.

FIG. 3 is an exploded perspective view.

FIG. 4 is a longitudinal cross-sectional view indicated by line 4-4 of FIG. 2.

### DETAILED DESCRIPTION OF CERTAIN EMBODIMENTS

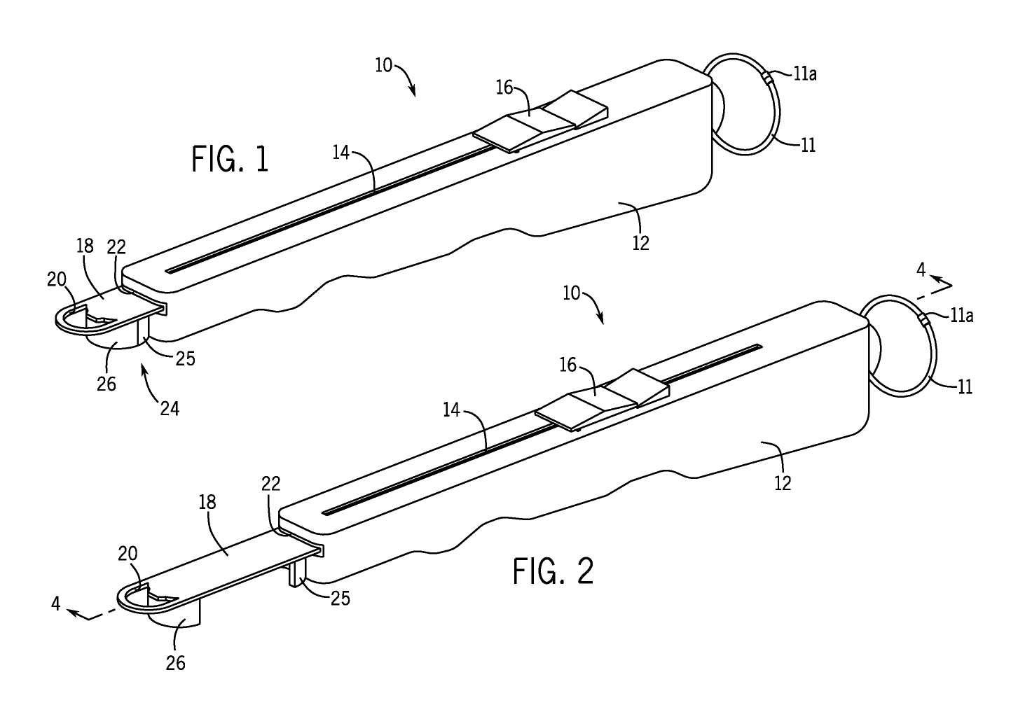

By way of example, and referring to FIG. 1 and FIG. 2, one embodiment of container opener 10 comprises housing 12. A rear surface on housing 12 comprises key ring 11 which further comprises clasp 11a. A top surface on housing 12 comprises top slot 14 which is configured to accommodate slider and locking unit 16. Slider and locking unit 16 is mechanically coupled to adjustable blade 18. Adjustable blade 18 further comprises bottle opener 20 at one distal end and is mechanically coupled to movable jaw member 26. Housing 12 is further mechanically coupled to stationary jaw member 25.

When acting in concert, stationary jaw member 25 and movable jaw member 26 are both concave inward and form grip 24. A user can slide adjustable blade 18 in and out of front slot 22 on body 12 to find an ideal length or distance for configuring grip 24 to fit the lid of a jar, bottle or collectively, a container. When slider and locking unit 16 is depressed adjustable blade 18 can move. Likewise, when slider and locking unit 16 is released adjustable blade 18 is held in place. Once realized, a user can turn housing 12 as a lever to open the lid.

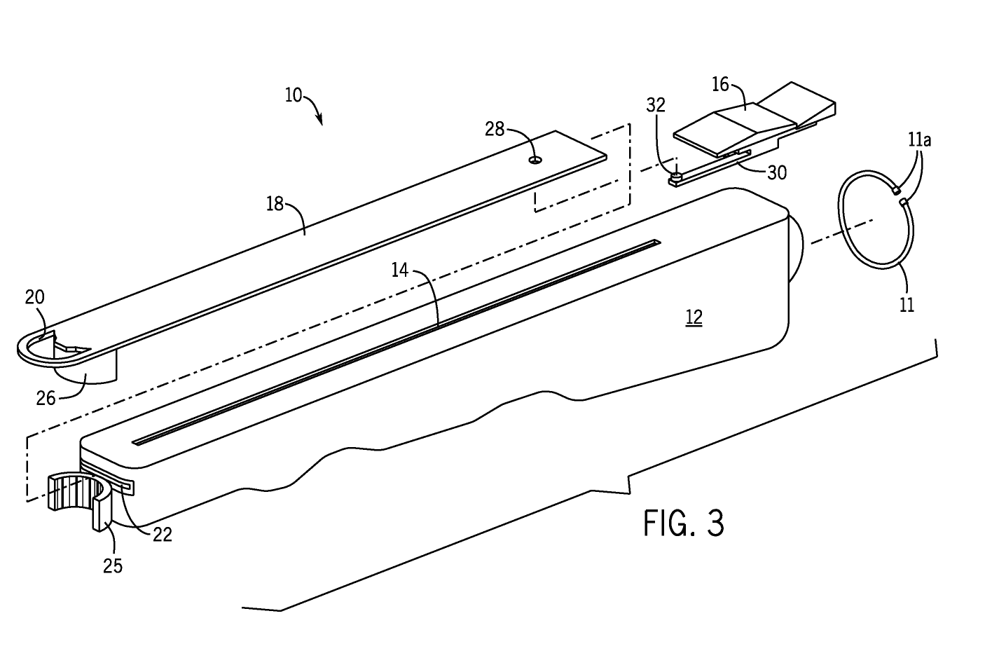

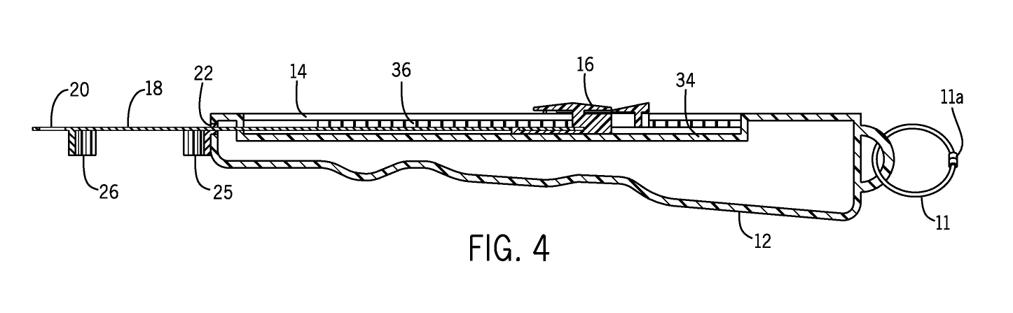

FIG. 3 and FIG. 4 show one theory of how to make container opener 10. Here, slider and locking unit 16 further comprises arm 30 mechanically coupled to boss 32. Adjustable blade 18 is perforated at connection point 28 which is configured to accommodate boss 32.

In some embodiments, bottle opener 20 can open beer or soda bottles. In some embodiments, adjustable blade 18 can be made from steel or any material with similar strength and flexibility and can be equipped with an adjustment gear which in turn is equipped with a locking mechanism configured to accommodate slider and locking unit 16. Stationary jaw member 25 and movable jaw member 26 are configured in an arcuate shape and mirror image one another. In some embodiments, housing 12 is made from plastic.

To use the device, while holding container opener 10 the user pushes adjustable blade 18 by putting the thumb on slider and locking unit 16 and pushing forward. Next, placing stationary jaw member 25 on the bottle cap/lid. After that pulling adjustable blade 18 in until movable jaw member 26 touches the other end of the cap/lid. Following that, either locking the position and turning housing 12 a little to the left; or you can leaving one's hand in position and turn container opener 10 to left and the lid is opened.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A container opener, configured to remove a lid from a container; the container opener comprising:
a housing configured with a top slot and a front slot;
an adjustable blade inserted into the housing through the front slot and mechanically coupled to a movable jaw member;
a slider and locking unit inserted into the top slot and attached to the adjustable blade such that movement of the slider within the top slot moves the adjustable blade in and out of the front slot;
a stationary jaw member attached to the housing;
wherein the movable jaw member is configured to be placed a distance from the stationary jaw member in order to hold the lid such that rotating the housing removes the lid from the container.

2. The container opener of claim 1, wherein the movable jaw member and the stationary jaw member are both concave inward to better grip the container.

3. The container opener of claim 1, wherein the slider and locking unit further comprises an arm mechanically coupled to a boss; and the adjustable blade is perforated at a connection point which is configured to accommodate the boss.

4. The container opener of claim 1, wherein a rear surface on the housing comprises a key ring which further comprises a clasp.

5. The container opener of claim 1, further comprising a bottle opener configured within the adjustable blade.
